(19) United States
(12) Patent Application Publication
(10) Pub. No.: US 2006/0183958 A1
(43) Pub. Date: Aug. 17, 2006

(54) Process for the treatment of waste metal chlorides

(76) Inventor: William C. Breneman, Moses Lake, WA (US)

Correspondence Address: KLARQUIST SPARKMAN, LLP, 121 SW SALMON STREET, SUITE 1600, PORTLAND, OR, 97204, US

(21) Appl. No.: 10/551,517

(22) PCT Filed: Jul. 7, 2003
(86) PCT No.: PCT/US03/21267

§ 371 Date: Sep. 28, 2005

Related U.S. Application Data
(60) Provisional application No. 60/459,867, filed on Apr. 1, 2003.

(51) Int. Cl. C01D 7/12

(52) U.S. Cl. 588/313; 423/206.2

(57) ABSTRACT

A process is described for treating the residues from metal chlorination processes wherein valuable volatile metal chlorides or metalorgano chlorides are recovered while low volatility metal chlorides and chloride complexes are reacted with a neutralizing humectant. The resulting neutral, dry solid is suitable for land fill disposal or for recovery of valuable metal constituents by extractive metallurgy techniques.

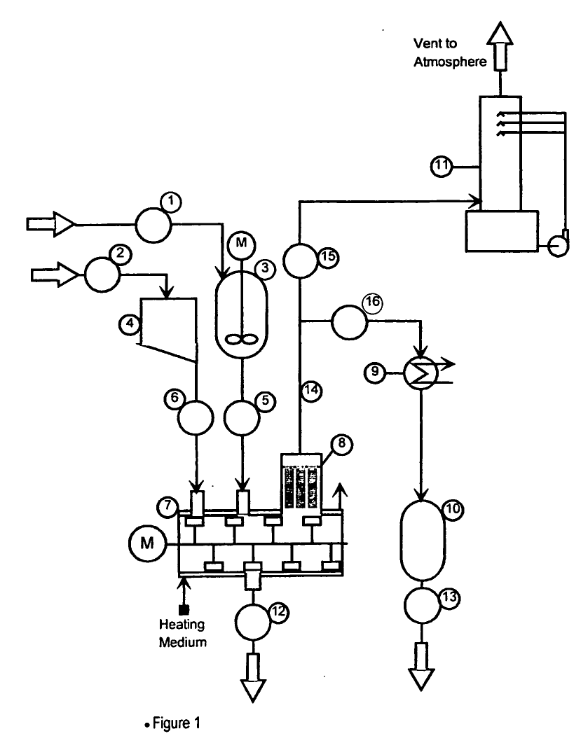

This claims the benefit of U.S. Provisional Application No. 60/459,867, filed Apr. 1, 2003, which application is incorporated herein by reference.

### BACKGROUND AND SUMMARY

The present invention relates to processes for rendering a solid residue material non-reactive to the normal ambient environment. It is particularly applicable to systems wherein a desired moisture-reactive volatile compound has been separated from a less volatile residue which then is discharged for disposal. Recovery of valuable and useful materials from the residue may be possible.

In the production of chlorosilanes, organochlorosilanes, titanium chlorides and other metal chlorides such as hafnium and zirconium chlorides, an impure solid metal or metal oxide of the primary product chloride is consumed. The impurities in the raw metal or metal oxide may or may not be reacted, but are rejected from the process as a solid mixture or slurry containing unreacted starting material, concentrated impurities from the starting material, chlorides of the impurity metal constituents and unrecovered chloride product. These combined residue mixtures when exposed to ambient atmosphere produce corrosive hydrogen chloride gas or hydrochloric acid and may also be flammable.

Examples of such procedures are the production of trichlorosilane, dichlorosilane and silicon tetrachloride by the hydrochlorination of silicon, the production of trichlorosilane by the hydrogenation of silicon tetrachloride over silicon metal, the production of silicon tetrachloride by chlorination of quartz, the production of organochlorosilanes by reaction of organochlorides, such as methyl and benzyl chloride with silicon, the production of titanium tetrachloride by chlorination of rutile ore, and the production of zirconium and hafnium chlorides by the chlorination of zircon containing sand.

In these processes, the unreacted portion of the raw material metal or metal oxide, which is sometimes referred to as “ash,” is rejected. The rejected material consists of a slurry mixture of insoluble metal, metal oxide, low volatility, water-reactive metal chlorides and a liquid phase of potentially recoverable product

By metal chlorides are meant chemical compounds such as aluminum chloride, titanium chloride, vanadium chloride, chromium chloride, manganese chloride, iron chloride, cobalt chloride, nickel chloride, copper chloride and zinc chloride. Those skilled in the art will recognize additional members of this group of low volatility, water-reactive metal chlorides. Such additional metal chlorides have a boiling point greater than 150° C. at atmospheric pressure and react upon contact with water to produce HCl.

The slurry is corrosive when exposed to moist air, flammable when dry and may contain environmentally hazardous components. Disposal of these metal/metal oxide/metal chloride mixtures requires that they be rendered non-reactive with air or moisture and be stabilized against mild acid leaching of the hazardous metal components. The residues may also contain valuable catalytic metals whose loss would be a significant economic penalty on the process.

In this disclosure, the discussion focuses on the production of trichlorosilane by hydrogenation of silicon tetrachloride. However, it should be appreciated by those skilled in the art that the described principals and practices would apply to all of the aforementioned processes which generate chloride containing metal and metal chloride residues and to other procedures where a moisture reactive volatile compound and a solid residue are to be separated with the volatile compound to be recovered and the solid residue material is needed to be rendered non-reactive to the normal ambient environment.

Chlorosilanes such as trichlorosilane and silicon tetrachloride are prepared by reacting crude silicon with chlorine or hydrogen chloride. Trichlorosilane can also be prepared by the reaction of silicon tetrachloride and hydrogen with crude silicon. In common industrial processing, for example as described in U.S. Pat. No. 3,878,291 (Keller) and U.S. Pat. No. 4,676,967 (Breneman), the crude silicon is of the type which has a silicon content greater than about 85% by weight.

The impurities in the crude silicon are mainly iron, aluminum, calcium, manganese, and titanium which are converted to their respective chlorides in an analogous method as the production of the chlorosilanes. In addition to these metals, other purposefully added metals may be present as catalysts and promoters. Such added active metals are copper, zinc, silver, and nickel. All of the non-silicon materials are rejected form the process as a “residue” or ash. Also, during the distillation purification of the chlorosilanes a residue fraction is generated. This distillation residue can contain fine particles of silica, higher boiling polychlorosilanes and traces of high boiling organic materials that may have been used as catalysts or promoters in other parts of the chlorosilane production process.

Customarily, the residues that result from the direct reaction and distillation purification are presented in the form of a slurry or suspension of solids and higher boiling liquids containing sufficient chlorosilanes to maintain fluidity. This stream requires additional processing to render it non-reactive or non-hazardous before it can be ready for environmentally safe disposal.

The distillation of the chlorosilanes is carried out as completely as possible because any chlorosilanes remaining in the residue can no longer be converted into useful products and therefore represent a loss in value. In those instances where the residues to be disposed of are in the form of a suspension, the solid fraction consists of unreacted silicon metal, silica and other metals and non-silicon metal chlorides. The solids are slurried in a liquid phase which contains 50-80% silicon tetrachloride and/or trichlorosilane and 1-30% hydrochloropolysilanes. This stream may be further concentrated in a screw-conveyor, heated ball mill or paddle type drier to recover essentially all of the silicon tetrachloride and trichlorosilane, leaving a solid, flowable residue that may include small chunks, sometimes referred to herein as “powder residue,” containing the metal chlorides, unreacted silicon metal, traces of silica, non-volatile organics and the like as described in U.S. Pat. No. 4,892,694 (Ritzer).

Various procedures have been disclosed to render the solid residue suitable for environmentally safe disposal. German Patent 21 61 641 discloses the reaction of a chlorosilane distillation residue with water vapor accompanied by the formation of hydrogen chloride. However, an adequate reaction takes place only with a stoichiometric excess of water vapor so that hydrochloric acid is produced from the excess water and hydrogen chloride which then also has to be treated before disposal. To avoid the formation of additional hydrochloric acid, U.S. Pat. No. 5,066,472 proposed to perform the hydrolysis in the presence of additional hydrogen chloride and recycle the unreacted water.

U.S. Pat. No. 4,690,810 discloses a process for the reaction of the chlorosilane residues with milk of lime to form a slurry of soluble calcium chloride and solid metal hydroxides and oxides. That process does not allow for reclaiming any of the valuable chlorosilanes required to provide fluidity to the residue and further requires a procedure to convert the calcium chloride solution into a commercial form, else adding to the already great environmental load.

Other procedures have been proposed to treat residues from the purification of chlorosilanes such as are generated during the production of polycrystalline silicon. Those processes involve hydrolysis of the residues, and neutralization of the resulting hydrochloric acid followed by filtration to remove the co-product silica. That process involves the use of expensive acid resistant equipment and the high maintenance costs associated with the processing of corrosive hydrochloric acid. Filtration of the resulting slurries is difficult and many times is just not possible as the hydrolysis reactions form unfilterable gels and ultra-fine particles.

The above-described processes, whether they concern the production of trichlorosilane, methylchlorosilanes, titanium tetrachloride or the rare earth chlorides, involve the step of contacting the residue with liquid water. The reaction of water with either the residual volatile metal chloride products or the metal chloride impurities contained within the residual solid metal or metal oxide results in the formation of corrosive hydrochloric acid. Therefore, the process equipment must be constructed of corrosion resistant materials. Leaks and spills provide a high likelihood of environmental contamination and worker exposure to corrosive materials. Furthermore, the aqueous hydrolysis of these metal chlorides results in the formation of solid metal oxides not only within the reaction mixture, but the solids can deposit on the interior portions of the equipment causing a process limiting build-up or plugging of pipelines, valves and other parts of the system.

Low cost procedures have now been found to maximize the recovery of valuable, moisture-reactive volatile compounds, while rendering the remaining residue non-hazardous for disposal or for recovery of valuable remaining metal impurities or catalysts. More particularly, methods for more economically processing the residues from chlorosilane production and/or other volatile metal chloride production processes to yield a waste product that can be readily disposed of, and preferably, to completely recover valuable volatile metal chlorides, have now been discovered. At least some of these methods allow an opportunity to reclaim valuable metals by well known extractive metallurgy techniques. Also, the processes typically can be conducted without need for equipment constructed of the exotic metals or materials required to be resistant to the corrosion of hydrochloric acid.

By such procedures, residues can be dried and the volatile chlorosilanes and organochlorsilanes (hereinafer referred to collectively as “chlorosilanes”), titanium chlorides or other metal chloride products can be recovered for re-use while the non-volatile solids, containing water-reactive, low volatility metal chlorides, are treated with an alkali carbonate or bicarbonate humectant to produce a non-fuming, neutral solid. The neutral solid is suitable for environmentally safe disposal. Alternatively, the residue may be further processed by extractive metallurgy methods to recover valuable metals.

### BRIEF DESCRIPTION OF DRAWING

The drawing FIGURE is a schematic flow sheet of a process for the treatment of waste metal chlorides.

### DETAILED DESCRIPTION

Particular methods described herein proceed without the formation of a liquid waste product and may comprise:

1) Evaporating the volatile chlorosilanes or metal chlorides in a suitable continuous or batch type drier, optionally, in the presence of a chloride complexing agent,

2) Condensing the evaporated chlorosilanes or valuable, and volatile metal chlorides and making them available for complete recovery and re-use, thereby significantly increasing the overall yield, and

3) Subjecting the substantially non-volatile solid residues and residue metal chlorides to the action of selected alkaline hydrate solids at a temperature in excess of about 80° C. (with most efficient operation at a temperature in the range of 120° C. to 150° C.) to yield a stable, neutral solid suitable for disposal or precious metal recovery.

The naturally occurring mineral, trona, is a usable alkaline hydrate material. Trona is inexpensive, readily available, and environmentally benign. The trona material used in the examples of this disclosure is T-200® mechanically refined trona sold by Solvay Mineral, Green River, Wyo. It is identified by CAS number 6106-20-3. Its chemical composition is nominally sodium carbonate (CAS 0497-19-8) 46%, sodium bicarbonate (CAS 0144-55-8) 36% and water (CAS 7732-18-5) 16%. T-200 trona is a powder having the following typical size characteristics:

| Sieve | Typical |
|---|---|
| Opening | Weight Percent |
| <70 μm | 75 |
| <28 μm | 50 |
| <6 μm | 10 |

The drawing illustrates the production of a residue and its treatment with a trona material.

A stream (1) of solids-laden chlorosilane to be treated originates from the hydrogenation of silicon tetrachloride over a fluidized bed of metallurgical silicon, or from the hydrochlorination of silicon metal in a fluidized bed reactor using hydrogen chloride, or from the residues of the distillation processes that purify trichlorosilane and silicon tetrachloride produced from these reactions. One or more of these streams can be combined into an agitated slurry collection vessel (3) that serves as an intermediate storage vessel prior to feeding the slurry (5) to the treatment system. The composition of the slurry can vary considerably, but may consist of components as listed in Table I.

TABLE I
Typical composition of waste chlorosilane/solid residue slurry

| | |
|---|---|
| Liquid Fraction, wt % | 77.6 |
| Trichlorosilane | 2.2 |
| Silicon tetrachloride | 83.6 |
| Cl₆Si₂O | 14.2 |
| Solid Fraction, wt % | 22.4 |
| Silicon (elemental) | 54.6 |
| Silica | 19.1 |
| Chloride | 16.1 |
| Iron | 4.5 |
| Aluminum | 2.9 |
| Carbon | 1.8 |
| Calcium | 0.5 |
| Titanium | 0.2 |
| Manganese | 0.2 |
| Copper | 0.1 |

In the illustrated method, the crude slurry (5) is flowed into a batch drier vessel (7) equipped with paddle type mixer, bag filter (8), heating jacket, and solid discharge valve (12). Other mechanical methods of performing the evaporation of the volatile chlorosilanes are possible and this example is not meant to limit the scope of the invention.

The evaporation/concentration can be enhanced if a complexing agent is added to reduce the volatility of the aluminum chloride and ferric chloride components in the solid residue mixture. A readily available and well known complexing agent is finely ground sodium chloride as described in Fannin, A. A.; King, L. A.; Seegmiller, D. W.; Oye, H. A. J. Chem. Eng. Data 1982, 27(2), 114-119. The finely milled sodium chloride can be added to the charge of slurry. The amount of sodium chloride added is nominally at least twice the weight of the estimated amount of aluminum chloride and ferric chloride contained in the remainder of the slurry. The sodium chloride is useful in forming a chemical complex with the aluminum chloride and ferric chloride contained in the slurry. The salt complex lowers the vapor pressure of the aluminum chloride and thus helps to retain the aluminum chloride and ferric chloride within the slurry solids while the volatile chlorosilane fraction is evaporated.

The charge of volatile chlorosilanes and mixed solids is sufficiently heated by a heating medium in the jacket of the drier to gasify the greater portion of the chlorosilanes; and the volatile chlorosilanes (14) are removed as a vapor. The chlorosilane vapors (16) are condensed in a condenser (9) and collected in a recovery vessel (10). A bag filter (8) may be employed on the drier to reduce the carry-over of fine particles with the chlorosilane vapors. In a preferred mode of operation, the drier may be recharged several times after the bulk of the chlorosilanes have been evaporated until the accumulated solids amount to about ¼ of the working volume of the drier. At this point, the temperature of the drier is raised to complete the evaporation of the chlorosilanes, which, at atmospheric pressure, is a temperature of about 70°-80° C.

The chlorosilanes collected in the receiver (10) may then be returned via a line (13) to the refining section of the chlorosilane production unit. The vent (14) from the drier is then switched to allow the vent gases (15) to pass to a suitable water spray scrubber (11) or similar treatment unit that is designed to remove residual amounts of hydrogen chloride from the vent gas stream.

A charge (2) of finely milled trona, natural sodium sesquicarbonate, is added to the drier (7) from a storage bin (4) via a lock chamber (6). The amount of trona to be added is such as to provide a pH greater than 7 in the residue solid. The optimum amount of trona to be added is generally determined by experiment since the composition of the residue material can vary. A modest excess of trona is desirable, but a greater excess presents only a minor additional cost. The mixture of dry solids and trona is heated to a temperature of between about 120° and 150° C., although higher temperatures may be used without negative effect. During the heating, hydrated moisture in the trona reacts with the metal chlorides and traces of chlorosilanes. Some HCl gas is formed, which reacts with the sodium carbonate portion of the trona. Additionally, as the trona is heated, it thermally decomposes to release additional moisture and carbon dioxide gas. The decomposition of the trona results in a porous solid which can readily react with the released hydrogen chloride gas. The released gas, mainly carbon dioxide, un-neutralized hydrogen chloride and excess moisture is vented to the scrubber (11).

The neutral, dry, free flowing solid consisting of the excess and decomposed trona, silicon metal, silica, and neutralized or hydrated metal chlorides is then cooled to a safe handling temperature and discharged via an outlet line (12). Provided sufficient trona has been used, the pH of a 10% aqueous slurry of the product solid is between 7 and 10.5 and no odor of hydrogen chloride is present in the dry solid.

The dry, neutral solids may be disposed of in a suitable landfill, or made available for recovery of selected metals using conventional extractive metallurgy methods.

Examples of suitable alkaline hydrates that may be used in the process are sodium or potassium sesquicarbonate, sodium aluminum sulfate dodecahydrate, sodium acetate trihydrate, sodium ammonium phosphate tetrahydrate, sodium carbonate decahydrate, sodium citrate dehydrate, sodium dihydrogen phosphate dehydrate, and mixtures of calcium carbonate or sodium carbonate, sodium bicarbonate, and/or other basic salts. In addition, inert hydrated minerals may be used such as Aluminite, Apophyllite, Bloedite, Chabazite, Gaylussite, Gmelinite, Heulandite, Kainite, Kieserite, Laumonitite, Levyne, Mesolite, Mirabilite, Montmorillonite, Mordenite, Natrolite, Newberyite, Phillipsite, Scolecite, Stilbite, Struvite, and damp soil. In the case of damp soil, excess water content can cause processing difficulties; a water content of about 5% (w/w) is suitable for most purposes. Soil may be mixed with lime, trona or other alkaline solid to provide sufficient neutralizing strength. In order to satisfy the requirements for non-hazardous land fill disposal, the basic anion(s) is/are generally limited to sodium, potassium, calcium, and magnesium and excludes lithium, rubidium, barium, strontium, and the like.

Although not to be bound by theory of operation, it is believed that the successful working of the disclosed processes depends on water trapped in the solid hydrate. The trapped water is not released until it is exposed to the “waste” which contains, e.g., aluminum chloride and iron chloride, and traces of residual chlorosilanes. Upon exposure to metal chlorides in the waste, the hydrate is at least partially dehydrated by a transfer of water to the metal chlorides. The transferred water forms aluminum chloride hydrate (for example) and silica. The amount of the hydrate supplied and the water content thereof should be chosen to be sufficient to completely hydrate all the metal chloride in the waste.

As there is a small amount of HCl also liberated during this reaction and subsequently during long term exposure, it is best to react the HCl with an alkaline salt to at least partially neutralize the hydrogen chloride. The alkaline salt may be provided by using an alkaline hydrated mineral to react with the metal chlorides, or a separate alkaline salt may be provided. For example, in the alkaline hydrated mineral trona, sodium carbonate and bicarbonate are present in sufficient excess to serve as alkaline salts that react with the hydrogen chloride and form harmless salt, water and carbon dioxide. Calcium carbonate and magnesium hydroxide are examples of separate alkaline salts that could be added to neutralize HCl.

The resulting dry, neutral, and free flowing residue solid can be safely disposed of in an environmentally acceptable manner. After discharge of the neutralized solids, the drier is ready for a subsequent charge of chlorosilane slurry with out need for further clean-up.

The discharged solids, which meet the requirements for non-hazardous solid waste by the “TCLP” or Toxic Characteristic Leaching Protocol of 40 CFR §268.49 (2003), may be discarded in any suitable manner.

Alternatively, if valuable metals, such as copper, nickel, or silver, are used as catalysts or promoters in the production of chlorosilanes, or organochlorosilanes, the dry neutral solid residue can be made available for recovery of those metals by conventional hydrometallurgy extraction techniques. For example, if the alkali carbonate hydrate used in the process was trona, natural sodium sesquicarbonate, washing the neutralized solid residue with water would remove the bulk of the sodium carbonate and sodium chloride. Then the remaining solid could be acidified with sulfuric acid to form soluble copper sulfate. The copper sulfate could then be extracted by an organic solution of an oxime in kerosene as described in U.S. Pat. No. 6,242,625.

Because moisture is carried into the process in the form of a hydrated solid, there is substantially no free moisture within the process. The water-reactive, low volatility metal chlorides, for example aluminum chloride, have a much stronger affinity for moisture than the alkali carbonate hydrate. Thus the environment within the drier is maintained in a state where no condensation of water or hydrochloric acid occurs, thus reducing the corrosive effect. Thus the drier can be constructed of a duplex stainless steel alloy such as Ferillium that is much less expensive than the nickel/chromium/molybdenum alloys or glass enameled equipment that would otherwise be required.

### EXAMPLE 1

1,160 Kg of a slurry consisting of 25% solid silicon and metal chlorides and 75% of a mixture of silicon tetrachloride and trichlorosilane was added to a horizontal paddle type drier constructed of Ferillium duplex stainless steel and having a processing volume of 3.24 m³. The drier was further equipped with an integral bag filter on the process vapor outlet to retain fine particles and a condenser was provided downstream of the bag filter to condense and collect volatilized chlorosilanes. 36 Kg of Cargill Microsized 66 finely ground sodium chloride was also added. At essentially atmospheric pressure, heat was applied to the jacket of the drier and the bulk of the chlorosilanes were boiled off and condensed into a receiver. When the batch temperature began to rise above 60° C. (the boiling point of silicon tetrachloride at process pressure), a fresh charge of 1,160 kg of slurry was made and the boiling continued. This fill, boil, fill sequence was repeated until a total of 4,211 kg of slurry had been charged. After the last slurry charge, the drier temperature was allowed to rise to 80° C. to complete the evaporation of the chlorosilane. The drier vent was switched to a water spray vent scrubber and a charge of 250 kg of Solvay® T-200® finely ground trona, natural sodium sesquicarbonate, was added to the drier. The temperature of the drier was raised to 130° C. over a period of one hour and held there for an additional two hours to assure complete reaction The batch was cooled to less than 5° C. and a fine gray powder solid was discharged to a bin. A 10% slurry of the powder in water indicated a pH of 10.3. The powder did not present any acidic odor, was free flowing and did not ignite when heated in air.

### EXAMPLE 2

A slurry consisting of 110 gram of solid residue from the hydrochlorination of silicon and 200 ml of silicon tetrachloride was placed in a 500 ml agitated flask that was fitted with several small TFE discs in the vapor path before a condenser. The slurry was gently heated to 80° C. while the silicon tetrachloride was evaporated. 18 gram of sodium sesquicarbonate powder was added to the flask and the temperature was increased to 130° C. After holding the temperature for two hours, the flask was cooled and the residual dry waste product had an indicated pH of 10.4. During the heating cycle, a yellow/white fume was collected on the TFE discs placed in the cooler portions of the apparatus. 160 mg of fume consisting of >90% aluminum chloride with a minor amount of iron chloride were collected on the TFE discs.

### EXAMPLE 3

A slurry consisting of 110 gram of solid residue from the hydrochlorination of silicon (containing 5.4% Al, 2.6% Fe), 15 gram of finely ground sodium chloride and 200 ml of silicon tetrachloride was placed in a 500 ml agitated flask fitted with several small discs of TFE mounted in the vapor path below the condenser. The flask was heated slowly to evaporate the silicon tetrachloride. When the temperature reached 63° C., no more vapors were being removed. Then 30 g of Solvay T-200 finely ground trona (natural sodium sesquicarbonate) were added and the heating continued up to 160° C. After cooling, the residual solids were free flowing and odor free. The pH was 9.9. During the heating cycle, there was a markedly lower amount of white fume noticed. The amount of fume collected on the TFE discs was reduced to 8.5 mg of aluminum chloride (from 160 mg in Example 2).

### EXAMPLE 4

From the production of methylchlorosilanes by the direct reaction of methylchloride and a copper catalyzed metallurgical grade silicon metal, a residue is produced. The residue consists of a solid fraction containing unreacted silicon metal with alloyed copper, metal chlorides such as aluminum chloride, ferric chloride, and other solid metal silicides and oxides. The liquid fraction contains a mixture of volatile and non-volatile methylchlorosilanes and methylpolysiloxanes. 100 g of a slurry consisting of 5 g of solid fraction and 95 g of liquid methylchlorosilanes is charged to a flask having a paddle style agitator and a heating jacket. The flask is also fitted with a condenser and a receiver to collect the condensed vapors. The flask is heated to boil off the volatile methylchlorosilanes which are collected in the receiver. A second 100 g charge of slurry is made when the volume in the flask permitted, and is followed by a third 100 g charge in a similar manner. When the reaction flask reaches a temperature of 80° C., a flow of inert gas is begun to complete the evaporation of the volatile materials. A total of 250 gram of condensate is recovered.

The solid residue after having been held at 80° C. under a inert gas purge is converted into a slightly coherent solid mass. The solid fumed in air and has the odor of hydrochloric acid.

To the solid residue is added 30 gram of finely ground sodium sesquicarbonate. There is a mild exotherm of about 5° C. The solid mixture is heated slowly to a temperature of 150° C. over a period of a hour and then cooled to room temperature. The resulting mixture is a free flowing dark gray solid that had no detectable odor of hydrogen chloride. A water slurry of the solid indicates a pH of 7-10.

### EXAMPLE 5

From the manufacture of titanium tetrachloride by the chlorination of rutile ore, the “ash” from the chlorination process consists of unreacted oxides and non-volatile metal chlorides. 25 g of “ash” is added to an agitated reactor having a heating jacket and a solids addition funnel. The solids have a strong odor of chlorine and fumed mildly in moist air. Under an inert gas purge, the charge is heated to 80° C. At that point, 50 g of finely ground sodium sesquicarbonate is added to the mixer. The temperature of the mixer is slowly increased to 150° C. under an inert gas purge. After cooling to room temperature, the solids remains free-flowing and has no significant odor. The pH of an aqueous slurry of the solids is between 7 and 10.

While the foregoing description and examples relate primarily to the treatment of residues of silicon hydrochlorination, chlorosilane distillation processes, titanium manufacture and methylchlorosilane processes, it should be appreciated that the methods described herein have broader applicability. The process could apply to other situations where a moisture-reactive volatile compound and a solid residue are to be separated, with the volatile compound to be recovered, and with the solid residue material to be rendered non-reactive to the normal ambient environment.

1. A method of processing a flowable solid material that includes at least one low volatility, water-reactive metal chloride, the method comprising:
combining a flowable solid material that includes at least one low volatility, water-reactive metal chloride with a powdered hydrate to provide a mixture;
heating the mixture at a temperature greater than 80° such that a low volatility, water-reactive metal chloride in the flowable solid material reacts with the hydrate; and
discharging the resulting mixture for disposal or metals recovery.

2. A method of claim 1 wherein the heating is carried out with the mixture further comprising milled sodium chloride.

3. The method of claim 1 wherein the power material contains at least one metal chloride selected from the group consisting of aluminum chloride, titanium chloride, vanadium chloride, chromium chloride, manganese chloride, iron chloride, cobalt chloride, nickel chloride, copper chloride, and zinc chloride.

4. The method of claim 1 wherein the flowable solid material is from the production of chlorosilanes.

5. The method of claim 1 wherein the flowable solid material is from the production of methylchlorosilanes.

6. The method of claim 1 wherein the flowable solid material is from the production of titanium chloride.

7. The method of claim 1 wherein the flowable solid material is from the production of hafnium and zirconium chloride.

8. A method of processing the residue from a chlorosilane manufacturing process, the method comprising:
concentrating a residue mixture containing volatile chlorosilanes and lower volatility components including at least one water-reactive metal chloride in a drier unit suitable for processing a solid fraction;
separating volatile chlorosilane vapors from the mixture;
contacting the remaining substantially chlorosilane-free solid residue with a hydrate at a temperature greater than 80° such that the at least one water-reactive metal chloride reacts with the hydrate; and
discharging the resulting powder mixture.

9. The method of claim 8 further comprising contacting the substantially chlorosilane-free solid residue with an alkaline salt to increase the pH of the resulting powder mixture.

10. The method of claim 8 further comprising, simultaneously:
contacting the remaining substantially chlorosilane-free solid residue with a hydrate; and
contacting the remaining substantially chlorosilane-free solid residue with the alkaline salt.

11. The method of claim 10 wherein the contacting of the remaining substantially chlorosilane-free solid residue with a hydrate and the contacting of the remaining substantially chlorosilane-free solid residue with the alkaline salt is accomplished by contacting of the remaining substantially chlorosilane-free solid residue with mechanically refined trona, which is a natural form of sodium sesquicarbonate, is a hydrated mineral, and provides an alkaline salt.

12. The method of claim 8 wherein:
the alkaline salt comprises calcium carbonate; and
the hydrate comprises damp natural soil.

13. The method of claim 8 wherein:
the alkaline salt comprises magnesium hydroxide; and
the hydrate comprises montmorillonite clay.

14. The method of claim 8 wherein the residue mixture contains at least one metal chloride selected from the group consisting of aluminum chloride, titanium chloride, vanadium chloride, chromium chloride, manganese chloride, iron chloride, cobalt chloride, nickel chloride, copper chloride, and zinc chloride.

15. A method of processing the residue from a chlorosilane manufacturing process, the method comprising:
concentrating a residue mixture containing volatile chlorosilanes and lower volatility components including at least one water-reactive metal chloride in a drier unit that is suitable for processing a solid fraction in the presence of finely milled sodium chloride;
separating volatile chlorosilane vapors from the mixture in the drier unit;
contacting the remaining substantially chlorosilane-free solid residue with a hydrate in the drier unit at a temperature greater than 80° such that the at least one water-reactive metal chloride reacts with the hydrate; and
discharging the resulting powder mixture from the drier unit.

16. The method of claim 15 further comprising contacting the substantially chlorosilane-free solid residue with an alkaline salt to increase the pH of the resulting powder mixture.

17. The method of claim 16 further comprising simultaneously contacting the remaining substantially chlorosilane-free solid residue with a hydrate and contacting the remaining substantially chlorosilane-free solid residue with the alkaline salt.

18. The method of claim 17 wherein the contacting of the remaining substantially chlorosilane-free solid residue with a hydrate and the contacting of the remaining substantially chlorosilane-free solid residue with the alkaline salt is accomplished by contacting of the remaining substantially chlorosilane-free solid residue with trona, which is a natural form of sodium sesquicarbonate, is a hydrated mineral, and provides an alkaline salt.

19. The method of claim 15 wherein:
the alkaline salt comprises calcium carbonate; and
the hydrate comprises damp natural soil.

20. The method of claim 15 wherein:
the alkaline salt comprises magnesium hydroxide; and
the hydrate comprises montmorillonite clay.

21. The method of claim 15 wherein the at least one metal chloride is at least one metal chloride selected from the group consisting of aluminum chloride, titanium chloride, vanadium chloride, chromium chloride, manganese chloride, iron chloride, cobalt chloride, nickel chloride, copper chloride, and zinc chloride.
